(19) United States
(12) Patent Application Publication
(10) Pub. No.: US 2005/0269154 A1
(43) Pub. Date: Dec. 8, 2005

(54) Alien fall arrest safety system

(76) Inventor: John Siemienowicz, Amherst, NH (US)

Correspondence Address: Burns & Levinson LLP, Suite 300, 1030 Fifteenth Street, N.W., Washington, DC, 20005-1501, US

(21) Appl. No.: 11/138,637

(22) Filed: May 26, 2005

Related U.S. Application Data
(60) Provisional application No. 60/577,106, filed on Jun. 4, 2004.

(51) Int. Cl. A62B 37/00

(52) U.S. Cl. 182/3

(57) ABSTRACT

This invention relates an engineered fall-arrest mechanism that stops the free fall of up to two workers simultaneously. The invention is depicted in described in three preferred embodiments.

### CROSS REFERENCE TO RELATED APPLICATIONS

This application claims priority under 35 U.S.C. § 119 from provisional application Ser. No. 60/577,106, filed Jun. 4, 2004, and entitled “Alien Fall Arrest Safety System For Steel Erection Sites Technical Report”.

### FIELD OF THE INVENTION

This invention relates to construction and maintenance worker safety at industrial, commercial and other types of building work sites. More particularly, this invention is an engineered fall-arrest mechanism that stops the free fall of up to two workers simultaneously at a job site.

### BACKGROUND OF THE INVENTION

Building owners are responsible for providing a safe work environment for all employees, subcontractors and other workers. The failure of businesses to provide a safe work environment can cause excessive liability and other financial exposure.

Currently, roof top anchorages (otherwise known in the industry as “tie-offs”), requiring expensive field welding and extensive deck cutting and reinforcing, are widely employed as a method of worker safety for breaking falls at building and construction sites. Generally, workers are harnessed and tied off to a single rooftop anchorage that would break a potential fall. The welding, deck cutting and reinforcing of the currently employed systems significantly add to time spent at a site and increase the labor costs, fire hazards, and risks of incorrect installation. Furthermore, safety posts (roof top anchorage/tie-offs) also have to meet the requirements of the Occupational Safety and Health Organization (hereinafter referred to as “OSHA”) as described in Safety and Health Regulations for Construction (Part 1926), subpart M (Fall Protection), standard 1926.502, entitled Fall Protection Systems Criteria and Practices, paragraph d, Personal Fall Arrest Systems, and as described in Appendix C to this regulation entitled Personal Fall Arrest System—Non-Mandatory Guidelines for Complying with 1926.502(d).

Prior art safety mechanisms fall short of providing optimum effectiveness in dealing with cost and space restraints. U.S. Pat. No. 5,553,685, issued to Cook, discloses a roof safety anchor attachable to a rafter or joist. This anchor is securable to a single lifeline. For projects requiring a number of roof workers, space constraints and safety concerns prohibit the installment of significant number of safety anchors similar to the system disclosed in Cook. Many prior art fall arrest systems, including that of Cook, require the drilling of a plurality of nails and screws into the supporting structure that weaken the beam or rafter to which the arrest system is secured.

Roof anchors such as that disclosed by Curtin in U.S. Patent Application Publication No. 2004/0035993 A1 contain a large number of components, which can lead to faulty installation at a work site. These anchors also tend to be bulky and inefficient for a work site with significant space constraints.

### SUMMARY OF THE INVENTION

In one form of the invention, a fall arrest safety system is disclosed comprising an eye bolt having a proximal portion and a distal portion wherein the distal portion is partially threaded; an energy absoption mast located at the proximal portion having an upper assembly and a lower assembly, wherein the upper assembly includes a washer, an internally threaded fastener, and a plate, and wherein the lower assembly comprises a retainer, a washer, and at least one internally threaded fastener; a ring formed at the top of the energy absorption mast; and a slotted plate assembled over the ring.

In another form of the invention, a fall arrest safety system is disclosed comprising an eye bolt having a proximal portion and a partially threaded distal portion, the proximal portion having an upper assembly and a lower assembly, wherein the upper assembly includes a washer, an internally threaded fastener, and a first plate, and wherein the lower assembly comprises a retainer, a washer, and at least one internally threaded fastener; a jacket sub-assembly connected to the eye bolt and within the upper assembly, wherein the jacket sub-assembly comprises a pipe having a top portion and a bottom portion, the top portion forming a weld joint with a second plate, and further wherein the first plate is sealed to the bottom portion of the pipe and located at the top of the partially threaded distal portion of the eye bolt; a ring connected to the top of the jacket sub-assembly; and a slotted plate assembled over the ring.

In yet another form of the invention, a fall arrest safety system is disclosed comprising a bolt having a proximal portion and a partially threaded distal portion, the proximal portion having an upper assembly and a lower assembly, wherein the upper assembly includes a water-tight washer, and a first plate, and wherein the lower assembly comprises a retainer, a washer, and at least one internally threaded fastener; a jacket sub-assembly connected to the bolt and within the upper assembly, wherein the jacket sub-assembly comprises a pipe having a top portion and a bottom portion, and further wherein a second plate is sealed to the bottom portion of the pipe and located at the top of the partially threaded distal portion of the bolt; and the first plate is horizontally sealed to the top portion of the jacket sub-assembly.

The key feature of the invention is the use of a bolt as a tension member. It is an object of the invention for the tension member and the resultant compression forces to provide secure attachment of the product and break off falls, eliminate the need for welding and expensive reinforcing, and create a pre-fabricated system easy to install in the field.

It is another object of the present invention to eliminate expensive field welding and extensive deck cutting and/or additional structural reinforcing on new buildings resulting in cost savings via the tensioned installation of the system through either a beam or a joist girder. Using a beam or joist girder to install a fall arrest system is well known in the art.

It is yet another object of the present invention to provide a system that is light-weight and has a minimal number of components to ease the installation at site and reduce the chances of faulty installations. On existing buildings, this invention would be simply and economically installed through a membrane roof with minimal chance of leaks. Another object of the present invention is to eliminate the need for expensive field welding and in doing so also eliminate the risks and fire hazards associated with these activities.

Still another object of the present invention is to provide a system that does not use any nails, screws or other non-customized attachment items. The lightness of the system further eliminates the additional reinforcement of the building frame which may be required with other heavier systems. Another object of the present invention it to eliminate the use of stringing cables between the units where the workers are tied off. Since no suspended cables are present, potential tripping hazards from such systems are also eliminated. An additional object of the present invention is to provide a specific design for breaking the fall of a worker on a construction site to meet the OSHA requirements, and is not a simple piece of equipment for tie-off like an anchor.

If a repair or replacement is necessary, this can be easily seen since the unit is not encapsulated. It is another object of the invention that the energy of a potential fall is absorbed through the material of a first embodiment of the invention, and wear and tear can easily be seen and the unit be replaced. Still another object of the present invention is that the system will be used only on steel frames after a steel frame is erected, and not during the construction of a frame. It does not provide any rail protection.

It is an object of the first embodiment of the present invention to deflect and absorb some of the energy of the fall, further protecting the worker from stress applied by the worker's harness during the fall event.

### BRIEF DESCRIPTION OF THE DRAWINGS

FIG. 1 is an example of a square plate for use in a first embodiment in accordance with the present invention.

FIG. 2 depicts an example of a channel for use in a first embodiment in accordance with the present invention.

FIG. 3 illustrates the assembly of a first embodiment in accordance with the present invention.

FIG. 4 illustrates the assembly of the first embodiment with a slotted circular plate in accordance with the present invention.

FIG. 5 is an example of a channel for use in a second embodiment in accordance with the present invention.

FIG. 6 is an example of a square plate for use in a second embodiment in accordance with the present invention.

FIG. 7 is exemplary of a slotted circular plate for use in a second embodiment in accordance with the present invention.

FIG. 8 illustrates the assembly of the second embodiment in accordance with the present invention.

FIG. 9 illustrates the assembly of the second embodiment with a slotted circular plate in accordance with the present invention.

FIG. 10 is an example of a circular plate with square hole for use with a third embodiment of the present invention.

FIG. 11 is an example of a channel for use in a third embodiment in accordance with the present invention.

FIG. 12 is an example of a rectangular plate for use with the third embodiment of the present invention.

FIG. 13 illustrates the assembly of the third embodiment in accordance with the present invention.

FIG. 14 illustrates the assembly of the third embodiment system with a rectangular plate in accordance with the present invention.

FIG. 15 illustrates the assembly of a first embodiment in a joist girder in accordance with the present invention.

FIG. 16 illustrates the assembly of a first embodiment on a beam in accordance with the present invention.

FIG. 17 illustrates the assembly of a second embodiment in a joist girder in accordance with the present invention.

FIG. 18 illustrates the assembly of a second embodiment on a beam in accordance with the present invention.

FIG. 19 illustrates the assembly of a third embodiment with a rectangular plate and in a joist girder in accordance with the present invention.

FIG. 20 illustrates the assembly of a third embodiment with a rectangular plate and on a beam in accordance with the present invention.

### DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The system of the present invention comprises upper and lower assembly units corresponding to above and below planes of the fixed and rigid installation points. All three embodiments of the invention (e.g. Alien™, Alien SS™ and Street Alien™) can be installed at girders fabricated from wide flange sections and/or at joist girders. The minimum flange requirement is at least 0.45 inches and girders must be properly connected at ends.

One of the advantages of the inventive system is that the various embodiments can be installed at the site without welding like most of the rooftop fall arrest systems require today. The system of the present invention also does not require an additional beam or trolley assembly like the carabineers (providing self-retracting lifelines) that is assembled to a fall protection trolley. Each embodiment is designed to anchor two employees using the proper safety lanyard, harness and any other appropriate gear. The present invention is calculated to have a shear rupture value of over 11,000 pounds and a tension rupture value of over 19,000 meeting or exceeding the OSHA Requirements for Construction (Part 1926, Subpart M).

Since the installation of any of the embodiments of the invention is not limited by welding or an extraneous crane or trolley beam, the present invention can easily be distributed across the entire construction or steel erection site simply by installing as many units of the invention as necessary for the job. The three preferred embodiments of the invention can be made a part of the permanent structure after an assessment conducted by a person responsible for installing and inspecting the system of the present invention.

Since the employees anchored to the present invention generally use a safety lanyard, harness and appropriate gear such as retractable lifeline, their range of reach will be limited by the type of accompanying equipment they use. The system of the present invention is a stationary unit and should not be removed to a different location once installed. The anchorage unit does not glide along the beams like some beam trolleys may provide today. It should be noted that the present invention will stop the fall, but not necessarily eliminate all the injuries that may be inflected by the actual fall and surrounding structures.

The system consists of a partially threaded rod or bolt roughly 2-feet in length. The threaded portion (bottom portion) is 1 foot long allowing installation through an assembly hole in a beam or the gap between the top chord members of a joist girder. The system is secured with a channel, a washer and two (a plurality) nuts assembled and tightened at the distal end of the threaded portion of the rod. These components are referred to as the lower assembly components hereafter. The other side of the tightened assembly (at the proximal threaded portion of the rod) is supported by either a nut, washer and plate combination or a square or round plate belonging to a jacket sub-assembly, depending on the embodiment of the invention.

The non-threaded portion of the system (top portion) is roughly 1 foot in length and terminates in a mechanism (e.g the “alien face” in each embodiment) for attachment of the workers' safety harness line. Depending on the version of the invention, the top portion is also used to house a jacket sub-assembly that reinforces the system against bending forces to meet the OSHA non-mandatory requirements for a non-engineered mechanism.

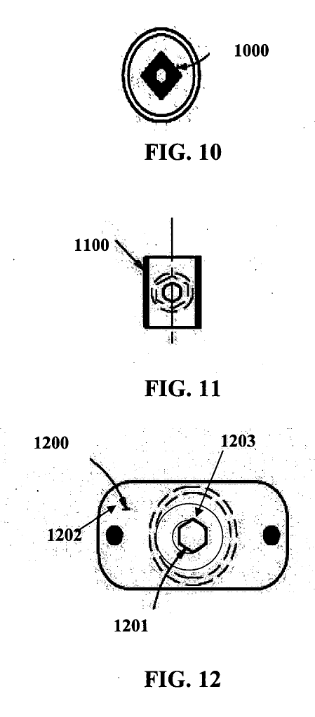

All three preferred embodiments incorporate a plate under the channel and uses double nuts. In an additional embodiment of the Street Alien system, depicted in FIGS. 10 through 14, the two holes providing locations for attachment of safety harness clips on the horizontal rectangular plate 1200 in FIG. 12 of the Street Alien system may be moved out to better accommodate the attachment of the safety harness clip.

Additionally, the circular plate 400 that is referred to as the Alien in the FIG. 4 of the Alien and FIG. 9 of the Alien SS embodiments is welded only on top and on the bottom contact points to the ring 401. This does not compromise any strength or safety to the unit.

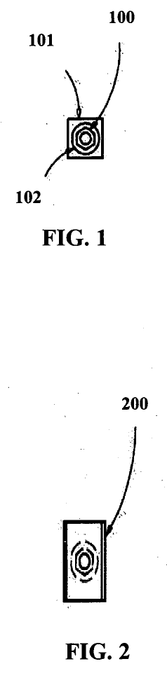

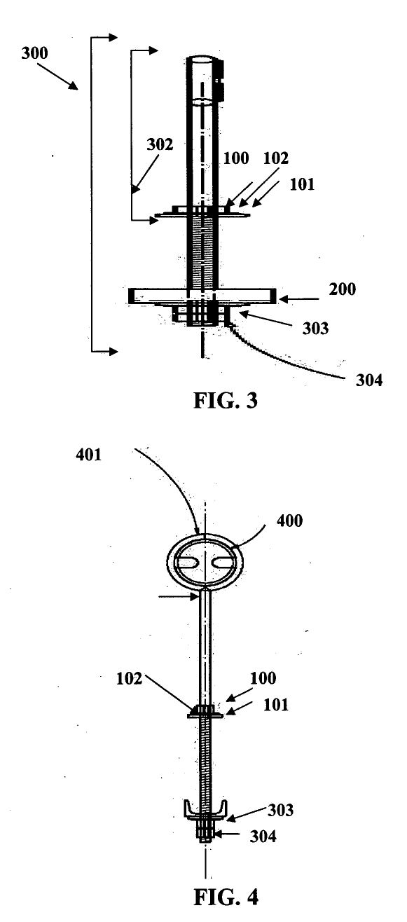

With respect to FIG. 1 through 4, the stainless steel rod 300 of the first embodiment, known as Alien and depicted in FIGS. 3 and 4, is approximately ¾-inch in diameter and approximately 2-feet 6 inches in length. The mechanism for attachment of the safety line consists of an approximate 5½ inch diameter ring 401, as can be seen in FIG. 4, formed at the top of the energy absorption mast 302 from the proximal portion of rod 300 and welded to close the ring 401 formed and create an eye bolt of approximately 2 feet and ¼ inches in length. The preferred material used to form the eye bolt is stainless steel; however other materials may be used in accordance with the present invention. The circular plate 400 has two slots, each roughly in the shape of a letter “u” oriented horizontally. The assembly of the slotted circular plate 400 over ring 401 provides for two locations where a safety harness clip may be secured.

The upper assembly components, depicted in FIG. 1 and assembled in FIG. 3, located at the proximal threaded portion include one approximately ¾-inch stainless steel nut 100, one approximately ¾-inch stainless steel washer 102 and a steel square plate 101 detailed in FIG. 1. The lower assembly components located at the distal threaded portion include a steel channel 200, which may be treated with primer, or other coatings or galvanized, as detailed in FIG. 2. The steel channel may also be manufactured without a surface treatment. FIG. 3 illustrates the side view of channel 200, while FIG. 4 provides a frontal view of the channel 200. In addition, the lower assembly, depicted in FIGS. 3 and 4 includes one approximately 4 inch washer 303 and two ¾ approximately inch nuts 304, all three components being stainless steel. As aforementioned, alternatives to stainless steel may be utilized in the system of the present invention.

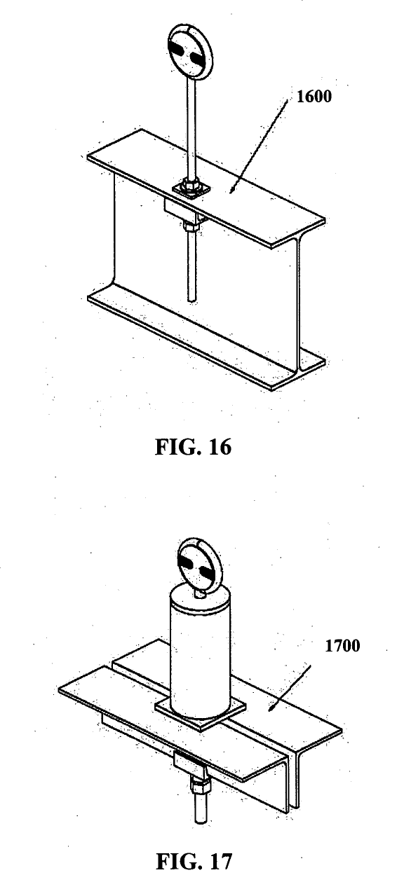

The Alien embodiment depicted in FIGS. 1 through 4 is designed such that as the threaded assembly components are tightened, a tensile force is established solely at the threaded portion of the rod 300. No force is exerted on the energy absorption mast 302 of the system upon assembly. Upon loading of the safety harness line, presumably by the fall of a worker, a load would be transferred to the attachment mechanism (the ring 401 covered by circular plate 400) and to the upper (non-threaded) portion (energy absorption mast 302 of the rod 300 in the form of a bending force. It should be noted that this version could be modified so that all components would be manufactured out of stainless steel, making this device suitable for use in a corrosive environment. FIGS. 15 and 16 illustrate the assembly of use in a first embodiment of the present invention in a joist girder 1500 and on a beam 1600, respectively.

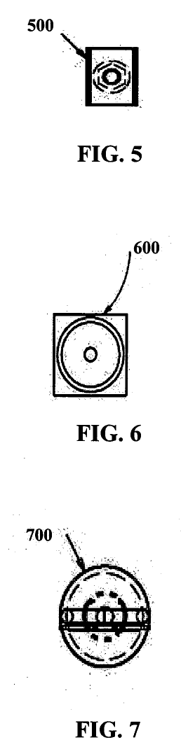

The stainless steel rod 300 of the second embodiment of the present invention, known as Alien SS (FIGS. 5 through 9), is approximately ⅞ inch in diameter stainless steel and is approximately 2 feet 6 inches in length. The mechanism for attachment of the safety line consists of an approximate 5½ inch diameter circular ring 401 formed out of the proximal portion of the rod 300. The end of the formed ring 401 is welded to the main rod 300 to create a joint, leaving an approximate 2 feet and ¼ inch of substantially straight length remaining in the rod 300. The face of the ring 401 is covered with an approximately 1/8 inch thick circular plate 401, illustrated in FIG. 7, made of stainless steel. The circular plate 400 has two slots, each roughly in the shape of a letter “u” oriented horizontally. The assembly of the slotted circular plate 400 over the ring 401 provides for two locations where a safety harness clip may be secured.

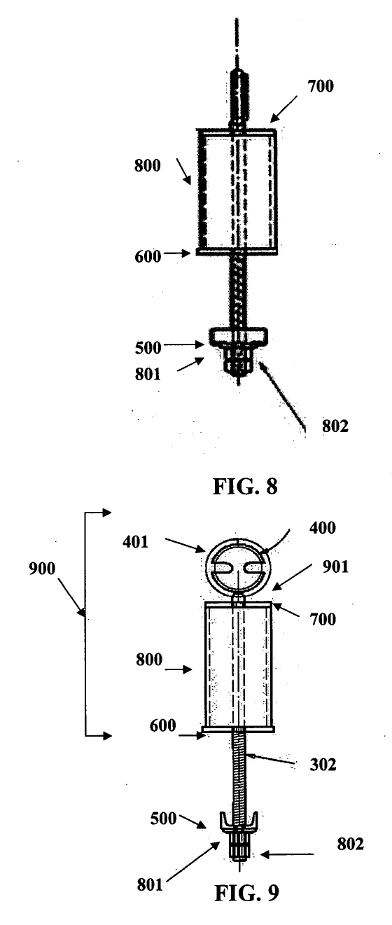

The upper assembly components in the Alien SS system consist of a jacket sub-assembly 900 containing circular plate 400, a pipe 800, and a square plate 600 (illustrated in FIG. 6), all components being stainless steel. The jacket sub-assembly 900 is attached to the main rod 300 of the Alien SS system by a welded joint 901 at the top of the rod 300 that is located immediately below the joint for the ring 401. The welded joint 901 provides a water-proof seal between the main rod 300 and the hole of the circular plate 400. The bottom of the circular plate 400 is welded and sealed to the top of a pipe 800, as detailed in FIG. 9. The bottom of the pipe 800 is in turn welded to the top of the square plate 600, as is illustrated in FIGS. 8 and 9.

FIGS. 8 and 9 illustrate that the square plate 600 is located at the top of the threaded portion of the rod 300, approximately 1 foot above the bottom of the Alien SS system. It is important to note that the approximately 7/8 inch diameter rod 300 is in clearance of the approximately 15/16 inch diameter hole in the square plate and that no method of attachment or welding is applied between the main rod 300 and the square plate 600. All rod components making up the eye bolt assembly are stainless steel and 7/8 inch in diameter. Upon assembly of the Alien SS system, the bottom surface of the square plate 602 comes into contact with the top surface of the beam 1800 or the top chord of a joist girder 1700.

The lower assembly components located at the distal threaded portion of FIGS. 8 and 9 include a steel channel 500, detailed in FIG. 5, that may be treated with primer, or other coatings, or galvanized. The steel channel may also be manufactured without any surface treatment. FIG. 8 illustrates the side view of channel 500, while FIG. 9 provides a frontal view of the channel 500. In addition, the lower assembly includes one approximately 7/8 inch washer 801 and two approximately 7/8 inch nuts 802, all three components made of stainless steel.

The Alien SS embodiment is designed such that as the assembly components are tightened, a tensile force is established through a majority of the length of the main rod 300. Specifically, the tensile force in the rod is established from the level of the lower assembly components 500, 801, and 802 to the level of the weld joint 901 of the circular plate 700 at the top of the jacket sub-assembly 800. Consequently, in accordance with the equilibrium of forces in a system, an equivalent compressive force is established through the length of the jacket sub-assembly 800. Specifically, the compressive force is established form the weld joint 901 of the circular plate 700 to the bottom of square plate 600.

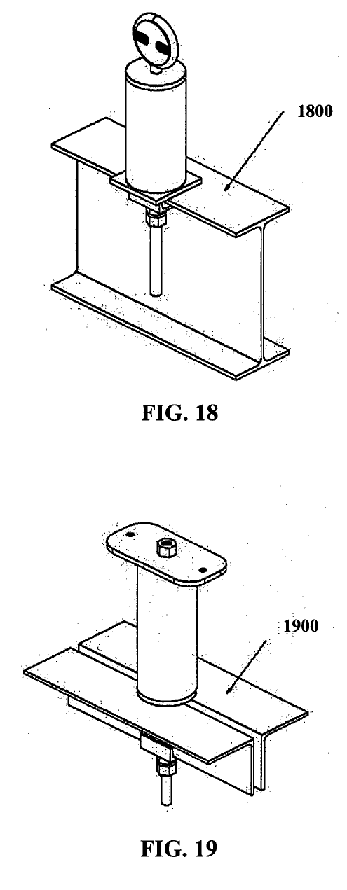

Upon loading of the safety harness line, presumably by the fall of a worker, a load would be transferred to the attachment mechanism (the ring 401 and the circular plate 700) and to both the pre-tensioned main rod 300 and the pre-compressed jacket sub-assembly 800 in the form of a bending force. The Alien SS embodiment is designed such that critical bending forces exerted on the system do not lead to excessive deflection or to yielding of the system. This design makes the Alien SS compatible with the OSHA non-mandatory requirement for non-engineered systems. It should be noted that this version could be modified so that all components would be manufactured from stainless steel, making this device suitable for use in a corrosive environment. All versions or components of choice could be manufactured from stainless steel, carbon steel with galvanization or carbon steel without galvanization. FIGS. 17 and 18 illustrate the assembly of the Alien SS system of the present invention in a joist girder 1700 and on a beam 1800, respectively.

The galvanized bolt 1304 of the third embodiment of the present invention, known as Street Alien (illustrated in FIGS. 10 through 14), is approximately 7/8 inch in diameter bolt and is approximately 2 feet 3 inches in length. The mechanism for attachment of the safety line consists of an approximately ½ inch thick rectangular plate 1200 with an area of 12×6 inches,) preferably manufactured of grade A36 steel. This plate is welded horizontally to the top of a jacket sub-assembly 1300 described below. The rectangular plate 1200 has a centrally located 15/16 inch diameter hole 1201 for assembly of the galvanized bolt 1304. Additionally, the rectangular plate 1200 has two 15/16 inch diameter holes 1202, each located a 5 inches from either side of the central hole 1201, near the ends of the plate. These holes 1202 are intended to provide a plurality of locations for attachment of safety harness clips.

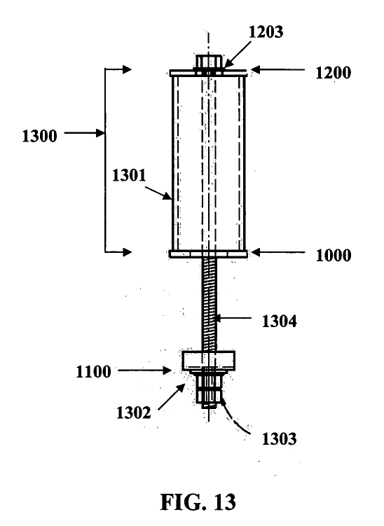

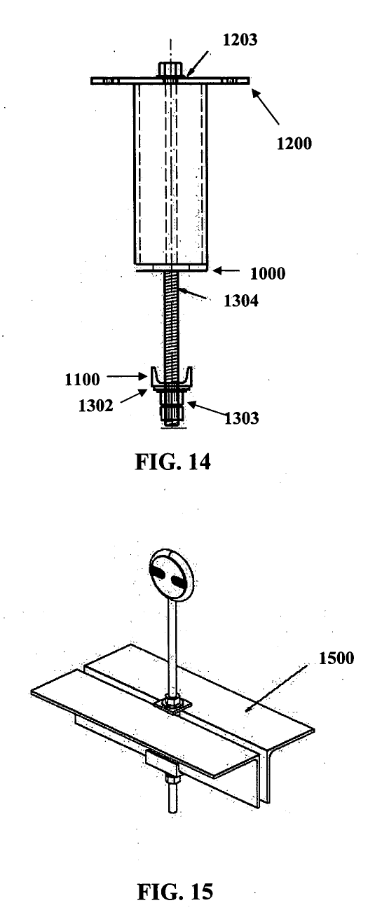

FIGS. 13 and 14 show the upper assembly components in the Street Alien system of the present invention contain a jacket sub-assembly 1300 containing a rectangular plate 1200, a pipe 1301, and a circular plate 1000 with a square hole. All components are fabricated out of steel and hot-dipped galvanized after assembly. The jacket sub-assembly 1300 is constrained by the head of the bolt 1304 assembled through a rubber water tight washer 1203 and the rectangular plate 1200, providing a water tight seal. The bottom of the rectangular plate 1200 is welded to the top of the pipe 1301 (approximately 1 foot 2 inches long), as detailed in FIG. 14.

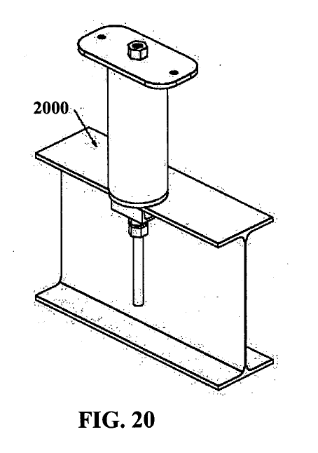

The bottom of the pipe 1301 is, in turn, welded to the top of the circular plate 1000 with a square hole. Figure Street Alien shows that circular plate 1000 is located at the top of the threaded portion of the bolt 1304, approximately 1 foot above the bottom of the Street Alien system. It is important to note that the approximately 7/8 inch diameter bolt 1304 is in clearance of the 2-inch square hole in the circular plate 1000 and that no method of attachment or welding is applied between the bolt 1201 and the circular plate 1000. Upon assembly of the Street Alien system, the bottom surface of the circular plate 1000 comes into contact with the top of the system of the beam 2000 (illustrated in FIG. 20) or the top chord of the joist girder 1900 (illustrated in FIG. 19).

The lower assembly components of the third embodiment of the present invention known as Street Alien are located at the distal threaded portion and include a steel channel 1100 detailed in FIG. 11 treated with Gray Primer. FIG. 13 illustrates the side view of channel 1100, while FIG. 14 provides a frontal view of the channel 1100. In addition, the lower assembly includes one approximately 7/8 inch washer 1302 and two approximately 7/8 inch nuts 1303, all three components being galvanized.

The Street Alien embodiment is designed such that as the assembly components are tightened, a tensile force is established through a majority of the length of the bolt 1304. Specifically, the tensile force in the bolt 1304 is established from the level of the lower assembly components to below the head of bolt 1304. Consequently, in accordance with the equilibrium of forces in the system, an equivalent compressive force is established through the length of jacket subassembly 1300. Specifically, the compressive force is established from the top of the rectangular plate 1200 to the bottom of the circular plate 1000. Upon loading of the safety harness line, presumably by the fall of a worker, a load would be transferred to the attachment mechanism (the rectangular plate 1200) and to both the pre-tensioned bolt 1304 and the pre-compressed jacket sub-assembly 1300 in the form of a bending force.

The Street Alien version is designed such that critical bending forces exerted on the system do not lead to excessive deflection or to yielding of the inventive system. It is important to note that this design makes the Street Alien compatible with the OSHA non-mandatory requirement for non-engineered systems. FIGS. 19 and 20 illustrate the assembly of the Street Alien embodiment of the present invention in the joist girder 1900 and on a beam 2000, respectively.

It will be readily apparent to those skilled in the art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. In particular, it is noteworthy that the plates in the three embodiments may be any geometric shape. It is intended that the specification and examples be considered as exemplary only, with a true scope and spirit of the invention being indicated by the following claims and their equivalents.

1. A fall arrest safety system, the system comprising:
(a) an eye bolt having a proximal portion and a distal portion wherein the distal portion is partially threaded;
(b) an energy absoption mast located at the proximal portion having an upper assembly and a lower assembly,
wherein the upper assembly includes a washer, an internally threaded fastener, and a plate, and wherein the lower assembly comprises a retainer, a washer, and at least one internally threaded fastener;
(c) a ring formed at the top of the energy absorption mast; and
(d) a slotted plate assembled over the ring.

2. The system of claim 1, wherein the internally threaded fastener of the upper assembly and lower assembly may be a nut.

3. The system of claim 1, wherein the retainer may be a channel or a plate.

4. The system of claim 1, wherein the plate may be substantially square.

5. The system of claim 1, wherein the ring may be substantially circular.

6. The system of claim 1, wherein the slotted plate comprises two slots for the attachment of a safety harness clip in each of said slots.

7. The system of claim 1, wherein the slotted plate may be circular.

8. A fall arrest safety system, the system comprising:
(a) an eye bolt having a proximal portion and a partially threaded distal portion, the proximal portion having an upper assembly and a lower assembly,
wherein the upper assembly includes a washer, an internally threaded fastener, and a first plate, and wherein the lower assembly comprises a retainer, a washer, and at least one internally threaded fastener;
(b) a jacket sub-assembly connected to the eye bolt and within the upper assembly,
wherein the jacket sub-assembly comprises a pipe having a top portion and a bottom portion, the top portion forming a weld joint with a second plate, and further wherein the first plate is sealed to the bottom portion of the pipe and located at the top of the partially threaded distal portion of the eye bolt;
(c) a ring connected to the top of the jacket sub-assembly; and
(d) a slotted plate assembled over the ring.

9. The system of claim 8, wherein the internally threaded fastener of the upper assembly and lower assembly may be a nut.

10. The system of claim 8, wherein the retainer may be a channel or a plate.

11. The system of claim 8, wherein the first plate may be substantially square.

12. The system of claim 8, wherein the second plate may be substantially circular.

13. The system of claim 8, wherein the ring may be substantially circular.

14. The system of claim 8, wherein the plate has a hole that is in clearance of the eye bolt when the system is assembled.

15. The system of claim 8, wherein the ring is formed by a rod.

16. The system of claim 8, wherein the slotted plate comprises two slots for the attachment of a safety harness clip in each of said slots.

17. The system of claim 8, wherein the slotted plate may be circular.

18. A fall arrest safety system, the system comprising:
(a) a bolt having a proximal portion and a partially threaded distal portion, the proximal portion having an upper assembly and a lower assembly,
wherein the upper assembly includes a water-tight washer, and a first plate,
and wherein the lower assembly comprises a retainer, a washer, and at least one internally threaded fastener;
(b) a jacket sub-assembly connected to the bolt and within the upper assembly,
wherein the jacket sub-assembly comprises a pipe having a top portion and a bottom portion, and further wherein a second plate is sealed to the bottom portion of the pipe and located at the top of the partially threaded distal portion of the bolt; and the first plate is horizontally sealed to the top portion of the jacket sub-assembly.

19. The system of claim 18, wherein the bolt, the first plate, and the jacket sub-assembly may be galvanized and may be protected by another weatherproof coating system.

20. The system of claim 18, wherein the first plate may be rectangular.

21. The system of claim 18, wherein the first plate has a central hole and at least one hole equally distanced from the central hole wherein the at least one hole provides a plurality of locations for the attachment of a safety harness clip in each of said holes.

22. The system of claim 18, wherein the retainer may be a channel or a plate.

23. The system of claim 18, wherein the internally threaded fastener of the upper assembly and lower assembly may be a nut.

24. The system of claim 18, wherein the second plate has a hole, which is in clearance of the bolt when the system is assembled.

25. The system of claim 18, wherein the second plate may be circular.
